(19) United States
(12) Patent Application Publication
(10) Pub. No.: US 2026/0131913 A1
(43) Pub. Date: May 14, 2026

(54) Ballistically Launched Part-Carrying Apparatus

(71) Applicant: Product Development Associates, Inc., Burnsville, MN (US)

(72) Inventors: Steven TRELLIS, Hopkins, MN (US); Bradley Vernon BRIERCLIFFE, Hastings, MN (US)

(21) Appl. No.: 18/781,410

(22) Filed: Jul. 23, 2024

(51) Int. Cl. B64U 20/80; B64D 1/00; G05D 1/689; G05D 105/55; G05D 105/85; G05D 111/50

(52) U.S. Cl. CPC B64U 20/80; B64U 10/11; B64U 30/293; B64U 70/70; G05D 1/689; G05D 2105/55; G05D 2105/85; G05D 2111/56

(57) ABSTRACT

A part-carrying apparatus includes a base portion. A shaft extends from the base portion. At least two mechanically driven arms are coupled to the shaft. Each arm has a first end coupled to the shaft and an opposite second end distal from the shaft. A part is coupled to the shaft. The part is configured to capture information about an environment around the part-carrying apparatus. A locking nut is coupled to the shaft. The locking nut comprises at least two positions. An unlocked position includes wherein the second end of each respective arm of the at least two mechanically driven arms is configured to extend away from the base portion when the locking nut is in the unlocked position. A locked position includes wherein the second end of each respective arm of the at least two mechanically driven arms is configured to extend towards the base portion when the locking nut is in the locked position.

### SUMMARY

A part-carrying apparatus includes a base portion. A shaft extends from the base portion. At least two mechanically driven arms are coupled to the shaft. Each arm has a first end coupled to the shaft and an opposite second end distal from the shaft. A part is coupled to the shaft. The part is configured to capture information about an environment around the part-carrying apparatus. A locking nut is coupled to the shaft. The locking nut comprises at least two positions. An unlocked position includes wherein the second end of each respective arm of the at least two mechanically driven arms is configured to extend away from the base portion when the locking nut is in the unlocked position. A locked position includes wherein the second end of each respective arm of the at least two mechanically driven arms is configured to extend towards the base portion when the locking nut is in the locked position.

A system includes a plurality of part-carrying apparatuses, each part-carrying apparatus comprising a base portion. A shaft extends from the base portion. At least two mechanically driven arms coupled to the shaft, each arm having a first end coupled to the shaft and an opposite second end distal from the shaft. A part is coupled to the base portion. The part is configured to capture information about an environment around the part-carrying apparatus. A locking nut is coupled to the shaft, the locking nut comprising at least two positions. An unlocked position includes wherein the second end of each respective arm of the at least two mechanically driven arms is configured to extend away from the base portion when the locking nut is in the unlocked position. A locked position includes wherein the second end of each respective arm of the at least two mechanically driven arms is configured to extend towards the base portion when the locking nut is in the locked position. A transmitter is configured to transmit the captured information to a base station. A receiver is configured to receive the captured information from the plurality of respective transmitters.

A method involves deploying a plurality of part-carrying apparatuses, each part-carrying apparatus is configured to capture information about an environment around the part-carrying apparatus while it is deployed and transmit the information to a base station. The information is received from each of the part-carrying apparatuses. A three dimensional image is produced by aggregating the information from each of the part-carrying apparatuses.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

The discussion below makes reference to the following figures, wherein the same reference number may be used to identify the similar/same component in multiple figures. The drawings are not necessarily to scale.

FIG. 1 illustrates an example part-carrying apparatus in accordance with various examples;

FIG. 2 illustrates the part-carrying apparatus disposed in a launcher in accordance with examples described herein;

FIG. 3 illustrates a launch of the part-carrying apparatus in accordance with examples described herein;

FIG. 4 illustrates the part-carrying apparatus after it has been launched into the air and is ascending in accordance with examples described herein;

FIG. 5 illustrates the part-carrying apparatus when it is descending in accordance with examples described herein;

FIG. 6 illustrates a process for producing a compound image from information retrieved from a plurality of part-carrying apparatuses in accordance with examples described herein; and

FIG. 7 illustrates a block diagram of a system and apparatus configured to perform the methods described herein.

### DETAILED DESCRIPTION

Situational awareness (knowing and tracking the locations of people and objects in a given area) during an emergency situation can mean the difference between a successful mitigation of a situation and a catastrophic result. These emergency events can be a result of natural catastrophe, unintended accident, or criminal endeavor, for example. The common factor across these events is the situation is chaotic, dynamic, and fast moving. The first responders responsible for managing the outcome of these events may benefit from reliable, real-time, visual information (situational awareness) so they can quickly assess and implement an appropriate set of actions. As the situation evolves, so does their plan. The more quickly the situation can be tracked, the more quickly the first responders can adapt and bring the event to a successful close; hopefully before events spiral out of control making a bad situation worse.

Embodiments described herein involves a part-carrying apparatus (e.g., a camera-carrying apparatus) that provides first responders with real-time situational awareness enabling them to proactively mitigate an emergency situation. The current alternative is to simply react as best they can with whatever knowledge they have at the time; which may in fact be limited to what they can see with their own eyes. Because emergency events can occur anywhere at any time, it may be beneficial that the part-carrying apparatus be physically small, easily transportable, and rapidly deployable with a minimum—preferably none—advanced planning required. While examples described herein involve the use of a part-carrying apparatus to be used in emergency situations, it is to be understood that the part-carrying apparatus may be useful in a wide range of non-emergency applications as well. The part-carrying apparatus may be ballistically launched to obtain greater vertical range and may have intentionally slowed decent engaging turning of the apparatus by a structured device.

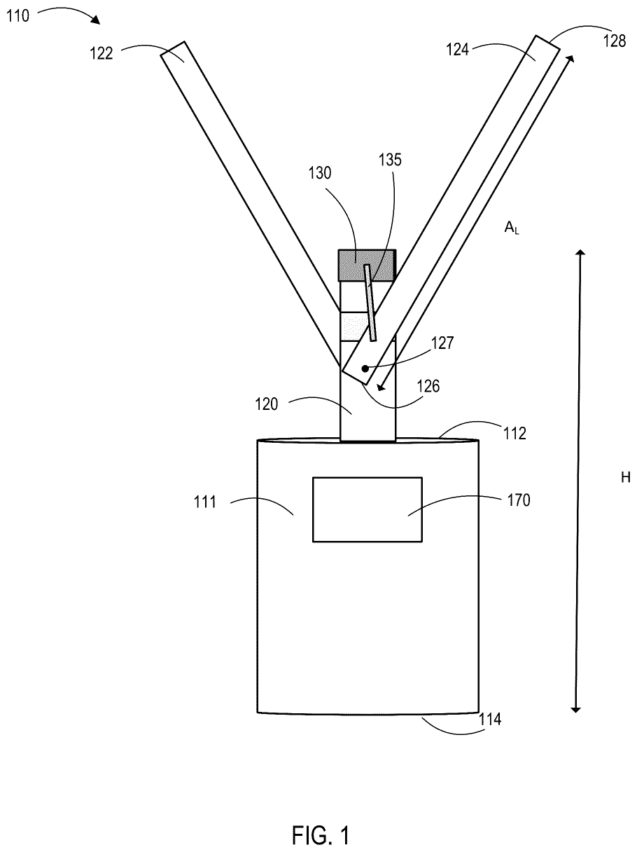

FIG. 1 illustrates an example part-carrying apparatus in accordance with embodiments described herein. The part-carrying apparatus includes a base portion 111 and a shaft 120 extending from the base portion 111. The base portion may be any shape. For example, the base portion may be substantially cylindrical. In some examples, the base portion has one or more corners. The base portion 111 may not be a uniform shape and/or size throughout the entirety of the base portion 111. For example, the base portion may have a different cross-sectional width at a first surface 112 when compared to a second surface 114 opposite the first surface 112. The shaft 120 may be any shape. In various configurations, the shaft 120 may be substantially cylindrical allowing for rotation when the part-carrying apparatus is deployed. The part-carrying apparatus 110 including the base portion 111 and the shaft has a height, H, in a range of 4 cm to about 40 cm or in a range of about 5 cm to about 20 cm. In some examples, the part-carrying apparatus 110 has a height in a range of 10 cm to about 15 cm.

A first arm 122 and a second arm 124 are coupled to the shaft 120. The arms 122, 124 each are coupled to the shaft at one end at an attachment point. For example, the second arm 124 is coupled to the shaft 120 at a first end 126 at the attachment point 127. A second end 128 of the second arm 124 extends away from the shaft 120. The arms 122, 124 may be attached to the shaft 120 by any suitable mechanism. For example, the arms 122, 124 may be coupled to the shaft 120 using one or more of a clevis pin and a dowel pin. The arms 122, 124 may be permanently attached or may be temporarily attached such that the arms 122, 124 can be removed when not in use. While the example shown in the figures herein shows a part-carrying apparatus having two arms, it is to be understood that more than two arms may be attached to the shaft 120. Each of the arms 122, 124 has a length, A_{L}, in a range of 6 cm to about 80 cm, or in a range of about 6 cm to about 30 cm. In some examples, each of the arms 122, 124 has a length in in a range of 6 cm to about 15 cm. While the arms 122, 124 shown in FIG. 1 are substantially the same length as each other, it is to be understood that the arms may be of unequal length.

One or more parts 170 may be coupled to the part-carrying apparatus. The part 170 may be configured to capture information about an environment around the part-carrying apparatus. For example, the part 170 may include one or more cameras and/or one or more microphones, for example. The part may include other components configured to facilitate the capturing, analysis and transmittal of the information captured by the cameras. For example, one or more storage devices may be configured to store the information collected by the cameras.

A transmitter may be configured to transmit the information collected by the cameras. In an example, a plurality of part-carrying apparatuses are configured to record images in a particular location from different perspectives. For example, the plurality of part-carrying apparatuses may be deployed in a location of an emergency such as a car crash, for example. The images and/or videos captured by each of the cameras may be transmitted to a central location where additional analysis and/or image aggregation may be performed. The analysis may be performed with input of a human operator. In some examples, at least some of the analysis is performed automatically, without input from a human operator. In some examples, all of the analysis is performed automatically and a collection of results are displayed via a display at the central location. In an example, the data from the plurality of part-carrying apparatuses is combined to produce a three dimensional image of the target area. In some examples, the part-carrying apparatus does not include a transmitter and the information may be manually retrieved from the part-carrying apparatus.

A locking nut 130 may be coupled to the shaft 120 and be configured to lock one or more of the arms 122, 124 in place in various conditions and will be described in more detail below. The locking nut 130 may include one or more protrusions 135. For example, there may be the same number of protrusions 135 as arms 122, 124 such that each protrusion is configured to couple the locking nut 130 to a respective arm. In the example shown in FIG. 1, the visible protrusion 135 couples the locking nut 130 to the second arm 124. The protrusion may be configured to exert pressure on the arms to lock them in place. The protrusion 135 may include any suitable material. For example, the protrusion 135 may include a string that is made of a strong, flexible material such as Kevlar, for example.

According to various configurations, the part-carrying apparatus 110 is configured to be launched into the air using a launcher. The launcher includes a shell that acts as the launching system whether containing black power for ignition, compressed gas for quick pressure release, etc. This shell's purpose is to, in one form or another, launch the apparatus into the air to obtain greater height. The shell may remain in the launcher while the part-carrying apparatus 110 ascends. The shell may allow the operator to place the apparatus within the shell in a void and on top of the pressure wadding.

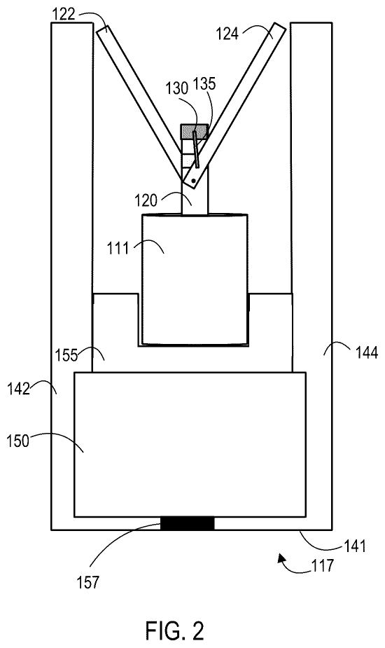

FIG. 2 shows the part-carrying apparatus disposed in a launcher 117. The launcher 117 includes shell having a base 141, a first wall 142 and an opposing second wall 144 are coupled to the base 141 such that a cavity is formed by the base 141, the first wall 142, and the second wall 144. A pressure chamber 150 is disposed within the cavity proximate the base 141. A fill port 157 may be configured to allow for material to be added to allow for the initiation of the launch. For example, the fill port 157 may allow for the addition of black power or compressed gas, for example, to be added to the pressure chamber 150. The fill port may have a seal to prevent or slow leaks of the pressurized material from the pressure chamber 150. A pressure wad 155 is disposed between the part-carrying apparatus 110 and the pressure chamber 150. The pressure wad 155 protects the part-carrying apparatus 110 from the exploding pressure of the propellant in the pressure chamber 150.

In various examples, the part-carrying apparatus 110 is stowed in the launcher 117 before it is launched. For example, the arms 122, 124 may be attached to a rod with the locking nut 130 in the unlocked position while being stowed as illustrated in FIG. 2.

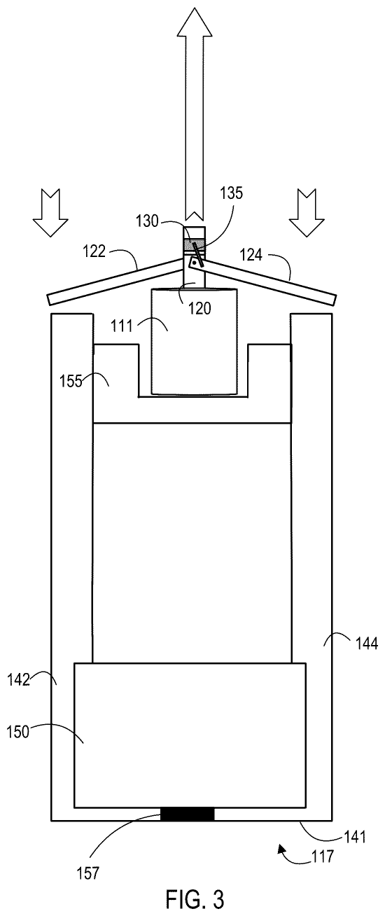

As the part-carrying apparatus 110 is being launched, the arms 122, 124 of the part-carrying apparatus 110 begin to fold onto the apparatus to help reduce drag on the apparatus to help obtain greater vertical height as shown in FIG. 3.

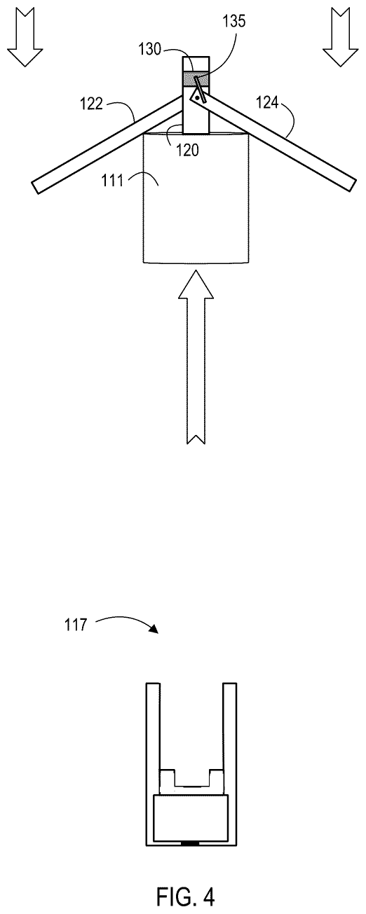

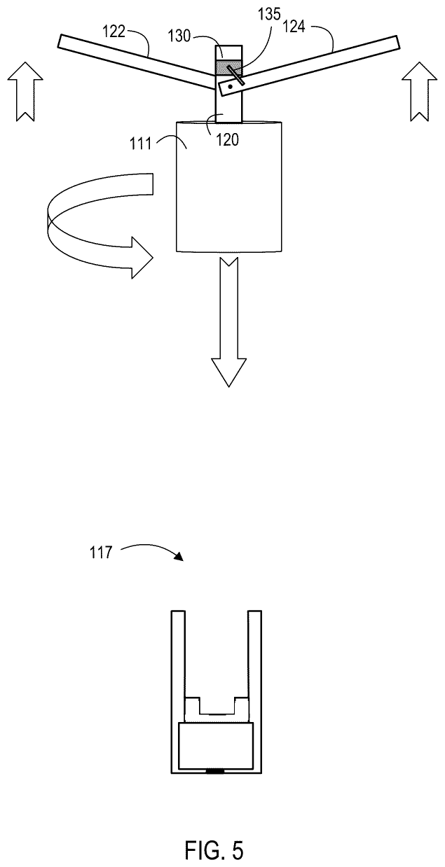

As the part-carrying apparatus 110, clears the shell and continues to ascend, the air resistance will push the arms down which will pull the locking nut 130 into a locked position to prevent the arms 122, 124 from going above a predefined latitude while the part-carrying apparatus 110 is descending. This downward fold is physically held down by the air resistance on top and limited also by the physical body of the part-carrying apparatus as shown in FIG. 4. When the apparatus reaches its apogee and begins to descend, as shown in FIG. 5, the arms 122, 124 will naturally, mechanically engage, which will engage the locking nut 130, to slow the apparatus's decent and turn the apparatus to engage a 360-degree turning sequence. This engagement is the level or upward fold and is physically engaged by and to the severity of the specific airfoil(s) of the mechanical arm(s) by generating lift to slow the descent of the apparatus. The physical limitation of the upward bounds of the arms 122, 124 is set by the locking nut 130 on top of the mechanical arms 122, 124. This turning sequence will allow the any cameras 170 on the part-carrying apparatus 110 to obtain a clear 360-degree view of the surroundings.

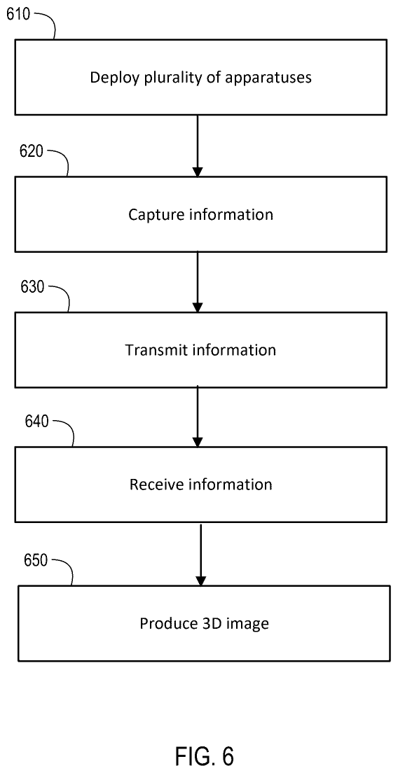

FIG. 6 illustrates a process for producing a compound image from information retrieved from a plurality of part-carrying apparatuses in accordance with examples described herein. The plurality of part-carrying apparatuses are deployed 610. They may be deployed using a ballistic launcher as described in further detail herein. In some examples, the part-carrying apparatus may be ballistically launched with an intentional, mechanically driven slowed decent using the arms and the locking nut.

Each part-carrying apparatus is configured to capture 620 information about the environment around the part-carrying apparatus. For example, each part-carrying apparatus may include at least one camera and may be configured to capture a plurality of images around the part-carrying apparatus. The captured information may be transmitted 630 to a base station by each part-carrying apparatus.

The information from each of the part-carrying apparatuses is received 640 at the base station. The information may include one or more images. Each image may be stored in a frame of a storage device having a plurality of frames. A three dimensional image is produced 650 by aggregating each of the images from the plurality of frames. Producing a three dimensional image by aggregating the plurality of images is described in more detail in U.S. patent application Ser. No. 18/781,314, which is incorporated by reference herein in its entirety.

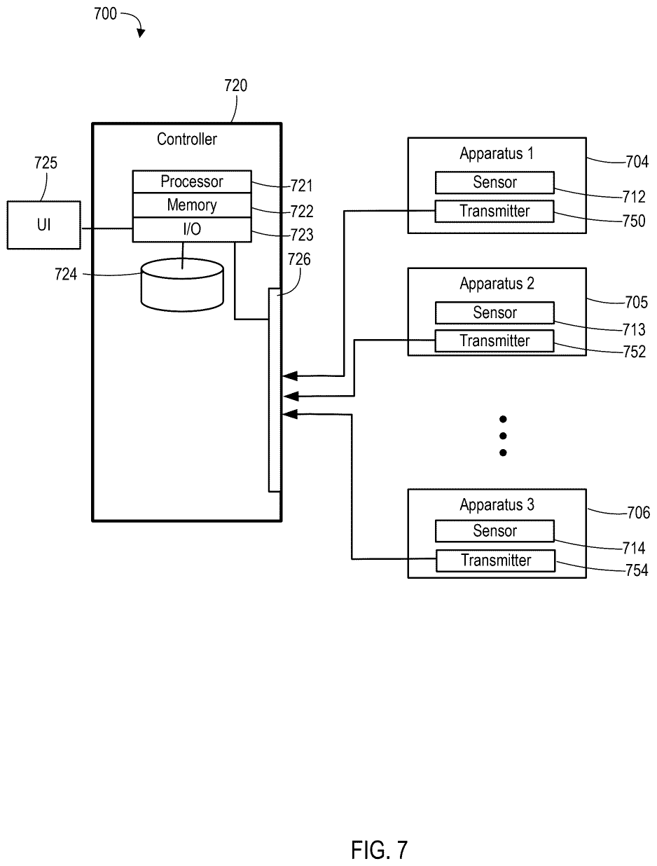

The methods and processes described above can be implemented on computer hardware, e.g., workstations, servers. In FIG. 7, a block diagram shows a system and computing apparatus 700 that may be used to implement methods according to an example embodiment (e.g., as a computer, a mobile device, a control system, etc.). The components may be implemented as integrated circuits (ICs), portions thereof, discrete electronic devices, or other modules, instruction sets, programmable logic or algorithms, hardware, hardware accelerators, software, firmware, or a combination thereof, or as components otherwise incorporated within a chassis of a larger system.

One or more part-carrying apparatuses 704, 705, 706 that collect information about a surrounding area are included. The apparatuses 704, 705, 706 may include various electrical and/or mechanical components of a self-contained system and may be discrete from other apparatuses.

Each of the apparatuses 704, 705, 706 is associated with sensors 712, 713, 714 configured to collect information and transmitters 750, 752, 754 that transmit the information to a central location be fed into a controller 720.

The sensors 712, 713, 714 may be described as either vision-based sensors or non-vision-based sensors. Vision-based sensors may include cameras that are capable of recording images and/or videos, for example. Non-vision-based sensors may include temperature sensors, optical sensors, humidity sensors, motion sensors, temperature sensors, for example. According to various examples, other types of sensors may be embedded in devices that collect data and communicate over the internet or grant mobile access for device management. Technologies include low energy wireless, Bluetooth, near field communication (NFC), long-term evolution (LTE), ZigBee, other wireless protocols, etc. Categories of these types of sensors may include smart home, smart city, automation, smart grid, and connected car, for example.

Data collected by the sensors 712, 713, 714 may be transmitted to a controller 720. The controller 720 may include conventional computing hardware such as a central processor 721, memory 722, input/output (I/O) interfaces 723, and a non-volatile data storage unit 724 (e.g., hard disk drives, solid state drives). The processor 721 may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor 721 may include multiple components, such as any combination of one or more microprocessors, one or more controllers, one or more DSPs, one or more ASICs, and/or one or more FPGAs, as well as other discrete or integrated logic circuitry. The functions attributed to the controller 720 and/or processor 721 herein may be embodied as software, firmware, hardware, or any combination of these. Certain functionality of the controller 720 may also be performed in the cloud or other distributed computing systems operably connected to the processor 721. It is to be understood that the computing devices described herein may be a set of computing devices that are communicatively coupled via a cloud-based system, for example. For example, controller 720 can be a system of multiple controllers that operate together in a cloud-based system.

The memory 722 may include any volatile, non-volatile, magnetic, optical, and/or electrical media, such as a random-access memory (RAM), read-only memory (ROM), non-volatile RAM (NVRAM), electrically erasable programmable ROM (EEPROM), flash memory, and/or any other digital media. While shown as both being incorporated into the controller 720, the memory 722 and the processor 721 could be contained in separate modules. The controller 720 includes an external data interface 726 that receives data from the sensors 712, 713, 714 and produces outputs that can be acted on via a user interface 725 that communicates sensor information to a user.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The various embodiments described above may be implemented using circuitry, firmware, and/or software modules that interact to provide particular results. One of skill in the arts can readily implement such described functionality, either at a modular level or as a whole, using knowledge generally known in the art. For example, the flowcharts and control diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to provide the functions described hereinabove.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

1. A part-carrying apparatus, comprising:
a base portion;
a shaft extending from the base portion;
at least two mechanically driven arms coupled to the shaft, each arm having a first end coupled to the shaft and an opposite second end distal from the shaft;
a part coupled to the shaft, the part configured to capture information about an environment around the part-carrying apparatus; and
a locking nut coupled to the shaft, the locking nut comprising at least two positions, comprising:
an unlocked position, wherein the second end of each respective arm of the at least two mechanically driven arms is configured to extend away from the base portion when the locking nut is in the unlocked position; and
a locked position, wherein the second end of each respective arm of the at least two mechanically driven arms is configured to extend towards the base portion when the locking nut is in the locked position.

2. The part-carrying apparatus of claim 1, wherein the part comprises at least one camera.

3. The part-carrying apparatus of claim 1, wherein the locked position is configured to be engaged based on a predefined amount of air resistance on the at least two mechanically driven arms.

4. The part-carrying apparatus of claim 1 wherein the at least two mechanically driven arms are configured to slow a descent of the part-carrying apparatus when the locking nut is in the locked position.

5. The part-carrying apparatus of claim 1 wherein the at least two mechanically driven arms are configured to engage a 360 degree turning sequence when the locking nut is in the locked position.

6. The part-carrying apparatus of claim 5, further comprising at least one camera, the at least one camera configured to capture a 360 degree view during the 360 degree turning sequence.

7. The part-carrying apparatus of claim 1, wherein the part-carrying apparatus is configured to be launched into air by a launcher.

8. The part-carrying apparatus of claim 1, further comprising a transmitter configured to transmit the information to a central location.

9. The part-carrying apparatus of claim 1, further comprising a launcher configured to launch a portion of the part-carrying apparatus.

10. The part-carrying apparatus of claim 1, further comprising:
a storage device for storing the captured information; and
a controller configured to cause the part to capture the information.

11. A system, comprising:
a plurality of part-carrying apparatuses, each part-carrying apparatus comprising:
a base portion;
a shaft extending from the base portion;
at least two mechanically driven arms coupled to the shaft, each arm having a first end coupled to the shaft and an opposite second end distal from the shaft;
a part coupled to the base portion, the part configured to capture information about an environment around the part-carrying apparatus;
a locking nut coupled to the shaft, the locking nut comprising at least two positions, comprising:
an unlocked position, the second end of each respective arm of the at least two mechanically driven arms configured to extend away from the base portion when the locking nut is in the unlocked position; and
a locked position, the second end of each respective arm of the at least two mechanically driven arms configured to extend towards the base portion when the locking nut is in the locked position; and
a transmitter configured to transmit the captured information to a base station; and
a receiver configured to receive the captured information from the plurality of respective transmitters.

12. The system of claim 11, wherein each part-carrying apparatus is associated with a launcher that is configured to launch the part-carrying apparatus into air.

13. The system of claim 12, wherein each launcher comprises:
a base;
a first wall and an opposing second wall, the first wall and the second wall coupled to the base, wherein a cavity is formed between the first wall, the second wall, and the base; and
a pressure chamber disposed within the cavity proximate the base;
wherein each part-carrying apparatus is configured to be disposed within the cavity proximate the pressure chamber before launch of the respective part-carrying apparatus.

14. The system of claim 13 wherein the pressure chamber is filled with a launch material configured to launch the part-carrying apparatus.

15. The system of claim 14, wherein the launch material comprises one or more of black powder and compressed gas.

16. The system of claim 14, wherein each respective base comprises an initiation cap configured to allow access to the pressure chamber through the base.

17. The system of claim 11, wherein each part-carrying apparatus comprises at least one camera.

18. A method, comprising:
deploying a plurality of part-carrying apparatuses, each part-carrying apparatus configured to:
capture information about an environment around the part-carrying apparatus while it is deployed; and
transmit the information to a base station;
receiving the information from each of the part-carrying apparatuses; and
producing a three dimensional image by aggregating the information from each of the part-carrying apparatuses.

19. The method of claim 18, wherein deploying the plurality of part-carrying apparatuses comprises ballistically launching each of the part-carrying apparatuses.

20. The method of claim 18, wherein each part-carrying apparatus comprises at least two arms configured to slow a descent of the part-carrying apparatus after it has been deployed.
